(19) United States
(12) Patent Application Publication
(10) Pub. No.: US 2025/0379677 A1
(43) Pub. Date: Dec. 11, 2025

(54) PARADIGM FOR FIBER OPTICS COMMUNICATION

(71) Applicant: NUtech Ventures, Lincoln, NE (US)

(72) Inventors: Jitender Deogun, Lincoln, NE (US); Dennis R. Alexander, Lincoln, NE (US); Valentin Laurent, Lincoln, NE (US)

(21) Appl. No.: 19/233,473

(22) Filed: Jun. 10, 2025

Related U.S. Application Data
(60) Provisional application No. 63/658,184, filed on Jun. 10, 2024.

(51) Int. Cl. H04J 14/02; H01S 3/00

(52) U.S. Cl. CPC H04J 14/0215; H01S 3/0085; H04J 14/0227

(57) ABSTRACT

A data transmission method is provided. The method includes generating a laser pulse in time domain. The laser pulse is configured based on a carrier-envelope phase (CEP). Based on the laser pulse, a signal spectrum in frequency domain is generated. The signal spectrum includes a range of frequencies. The signal spectrum in the frequency domain is modulated by selectively modifying one or more segments of frequencies within the range of frequencies. Based on the modulated signal spectrum in the frequency domain, a modulated laser pulse in the time domain is generated. Subsequently, the modulated laser pulse is transmitted through a communication network.

### CROSS REFERENCE TO RELATED APPLICATION

This Patent application claims priority to U.S. Provisional Patent Application No. 63/658,184, entitled “NEW PARADIGM FOR FIBER OPTICS COMMUNICATION” filed Jun. 10, 2024, which is incorporated herein by reference in its entirety.

### FIELD

The present disclosure relates to fiber optics communication, and more specifically to the modulation of optical signals.

### BACKGROUND

Fiber optic communication systems have become widely used due to their potential for high-speed, long-distance data transmission. However, despite progress in areas such as optical modulation, laser sources, and signal multiplexing, current technologies continue to face significant limitations. These include challenges in maintaining signal integrity over long distances, constraints on bandwidth and data throughput, and difficulties in achieving precise control over ultrafast optical pulses.

Conventional modulation techniques offer certain performance advantages, but may fall short in applications requiring high reliability, fine phase control, or advanced pulse shaping. Additionally, the increasing demand for faster and more secure communication systems has led to concerns such as data explosion (or “capacity crunch”) and data security.

### SUMMARY

The systems and methods according to the present embodiments provide novel paradigm for fiber optics communication.

A first aspect of the present disclosure provides a method for data transmission. The method includes generating a laser pulse in time domain, the laser pulse configured based on a carrier-envelope phase (CEP), generating, based on the laser pulse, a signal spectrum in frequency domain, the signal spectrum comprising a range of frequencies, modulating the signal spectrum in the frequency domain by selectively modifying one or more segments of frequencies within the range of frequencies, and generating, based on the modulated signal spectrum in the frequency domain, a modulated laser pulse in the time domain.

According to an embodiment of the first aspect, the method further includes transmitting the modulated laser pulse through a communication network.

According to an embodiment of the first aspect, the method further includes generating a plurality of laser pulses corresponding to one or more CEPs comprising the CEP, generating a plurality of modulated laser pulses corresponding to the plurality of laser pulses, multiplexing the plurality of modulated laser pulses to produce a plurality of multiplexed laser pulses, and transmitting the plurality of multiplexed laser pulses in the communication network.

According to an embodiment of the first aspect, the plurality of laser pulses are generated by a CEP-locked optical frequency comb. Each comb tooth corresponds to an independent communication channel. The plurality of laser pulses correspond to a plurality of independent communication channels. The communication network includes a plurality of spectrally discrete communication channels for data transmission.

According to an embodiment of the first aspect, wherein the plurality of laser pulses corresponding to the plurality of independent communication channels are multiplexed based on an ultra-dense wavelength-division multiplexing (UDWDM) scheme and transmitted in the plurality of spectrally discrete communication channels in the communication network.

According to an embodiment of the first aspect, the plurality of modulated laser pulses are multiplexed based on a holographic multiplexing scheme. Each modulated laser pulse of the plurality of modulated laser pulses is associated with an interrogating beam. The interrogating beam is used to isolate the respective modulated laser pulse from the plurality of multiplexed laser pulses at a receiving end.

According to an embodiment of the first aspect, in the frequency domain, the signal spectrum is associated with light spatially distributed across an optical plane, with the spatial distribution corresponding to the frequencies within the frequency range.

According to an embodiment of the first aspect, modulating the signal spectrum in the frequency domain includes at least one of: modulating, on the optical plane and using a spatial light modulator (SLM), an amplitude of the one or more segments of frequency within the range of frequencies, or blocking one or more segments of frequency within the range of frequencies.

According to an embodiment of the first aspect, modulating the signal spectrum in the frequency domain encodes the laser pulse to carry multi-bit information.

According to an embodiment of the first aspect, the communication network includes at least one of: fiber optics, atmospheric channels, and vacuum or near-vacuum communication paths.

According to an embodiment of the first aspect, the laser pulse is a CEP-locked ultrashort pulse. A duration of the CEP-locked ultrashort pulse ranges between 1 femtoseconds and 100 femtoseconds.

According to an embodiment of the first aspect, the method further includes: receiving the modulated laser pulse from the communication network, determining a second CEP for the received modulated laser pulse based on propagation of the modulated laser pulse through the communication network, detecting at least one intrusion attack based on the first CEP and the second CEP, and triggering an alarm based on detecting the at least one intrusion attack.

According to an embodiment of the first aspect, detecting the at least one intrusion attack includes: determining a phase shift in CEP based on the first CEP and the second CEP, and determining that the phase shift satisfies a condition corresponding to a reference phase shift.

A machine-readable medium is provided having stored thereon a set of instructions, which if performed by one or more processors, cause the one or more processors to perform the method for data transmission.

A second aspect of the present disclosure provides a device for data transmission. The device includes: a light source configured to obtain a laser pulse in time domain, the laser pulse configured based on a first carrier-envelope phase (CEP), an optical system comprising one or more optical components, the optical system configured to obtain, based on the laser pulse, a signal spectrum in frequency domain, the signal spectrum comprising a range of frequencies, and a modulator configured to modulate the signal spectra in the frequency domain by selectively modifying one or more segments of frequencies within the range of frequencies. The optical system is further configured to: obtain, based on the modulated signal spectrum in the frequency domain, a modulated laser pulse in the time domain, and transmit the modulated light signal through a communication network.

According to an embodiment of the second aspect, the light source is further configured to generate a plurality of laser pulses corresponding to one or more CEPs comprising the CEP. The optical system is further configured to obtain, based on the plurality of laser pulses, a plurality of signal spectra in frequency domain. The modulator is further configured to modulate the plurality of signal spectra. The optical system is further configured to: obtain, based on the plurality of modulated signal spectra, a plurality of modulated laser pulses in the time domain, multiplex the plurality of modulated laser pulses to produce a plurality of multiplexed laser pulses, and transmit the plurality of multiplexed laser pulses in the communication network.

According to an embodiment of the second aspect, the light source is a CEP-locked optical frequency comb. Each comb tooth corresponds to an independent communication channel. The plurality of laser pulses correspond to a plurality of independent communication channels. The communication network comprises a plurality of spectrally discrete communication channels for data transmission.

According to an embodiment of the second aspect, the plurality of laser pulses corresponding to the plurality of independent communication channels are multiplexed based on an ultra-dense wavelength-division multiplexing (UDWDM) scheme and transmitted in the plurality of spectrally discrete communication channels in the communication network.

According to an embodiment of the second aspect, the plurality of modulated laser pulses are multiplexed based on a holographic multiplexing scheme. Each modulated laser pulse of the plurality of modulated laser pulses is associated with an interrogating beam. The interrogating beam is used to isolate the respective modulated laser pulse from the plurality of multiplexed laser pulses at a receiving end.

According to an embodiment of the second aspect, modulating the signal spectrum in the frequency domain encodes the laser pulse to carry multi-bit information.

A third aspect of the present disclosure provides a device for data transmission. The device includes one or more processors configured to: determine, for a laser pulse received from a communication network, a carrier-envelope phase (CEP) of the laser pulse, determine a difference between the CEP of the laser pulse and a reference CEP corresponding to the data transmission using the laser pulse, and detect, based on the difference between the CEP and the reference CEP, existence of at least one intrusion during the data transmission.

According to an embodiment of the third aspect, the laser pulse received from the communication network is isolated from a plurality of multiplexed laser pulses by a demultiplexer.

### BRIEF DESCRIPTION OF THE DRAWINGS

FIG. 1A is a block diagram illustrating a communication system, in accordance with one or more embodiments.

FIG. 1B is a block diagram illustrating an example transmitter, in accordance with one or more embodiments.

FIG. 1C is a block diagram illustrating an example optical system, in accordance with one or more embodiments.

FIG. 2 illustrates a flowchart of a method for data transmission, in accordance with one or more embodiments.

FIG. 3A illustrates a flow diagram illustrating a method for modeling signal modulation, in accordance with one or more embodiments.

FIG. 3B illustrates an example laser pulse in time domain, in accordance with one or more embodiments.

FIG. 3C illustrates another example laser pulse in time domain, in accordance with one or more embodiments.

FIG. 3D illustrates an example signal spectrum in the frequency domain, in accordance with one or more embodiments.

FIG. 3E illustrates an example plot of a manipulated signal spectrum in the frequency domain and an example manipulated ultrashort laser pulse in the time domain, in accordance with one or more embodiments.

FIG. 3F illustrates another example plot of a manipulated signal spectrum in the frequency domain and another example manipulated ultrashort laser pulse in the time domain, in accordance with one or more embodiments.

FIG. 4A illustrates an example electrical field wave, in accordance with an embodiment.

FIG. 4B illustrates an example pulse shift, in accordance with an embodiment.

FIG. 5 illustrates a flowchart of a method for detecting intrusion, in accordance with one or more embodiments.

FIG. 6 is a block diagram illustrating a computer system configured to implement various functions, in accordance with one or more embodiments.

FIG. 7 is a block diagram illustrating an example communication system, in accordance with one or more embodiments.

### DESCRIPTION

Systems and methods are disclosed herein that relate to a communication paradigm for fiber optics communication, and in particular, to the modulation of optical signals, thereby advancing the capabilities of fiber optic communication networks, for example, to enable high-capacity and secure transmission. The communication paradigm can be implemented in new applications of communication networks such as data center, machine-to-machine connectivity, the Internet of Things (IoT), and cloud-based services, which are driving the exponential growth in data transmission through communication networks.

In at least one embodiment, the communication paradigm leverages the unique characteristics of carrier envelop phase (CEP) mode locked ultrashort lasers (e.g., femtosecond lasers and attosecond lasers when available). For example, femtosecond lasers generate ultrashort pulses, lasting a few femtoseconds (10⁻¹⁵ seconds) and offer unparalleled temporal resolution, and broad spectrum. In at least one embodiment, a duration of the CEP mode-locked ultrashort pulse ranges between 1 femtoseconds and 100 femtoseconds. In at least one embodiment, the communication paradigm utilizes the properties of the CEP of CEP mode locked ultrashort lasers for high-capacity and secure data transmission, offering variable-length word or sentences transmission instead of bit transmission.

In at least one embodiment, the communication paradigm utilizes the shaped carrier wave of ultrashort lasers in connection with one or more spatial light modulators (SLMs). The ultrashort laser pulses, characterized by their brief, high intensity bursts of light, serve as carriers of information. One or more SLMs are used to precisely shape the pulse and manipulate its spectral properties. In at least one embodiment, SLM is used to selectively dim specific frequency segments of a sequence of pulses, thereby effectively crafting a sequence of symbols. The symbols, embedded within the laser pulses, carry the encoded data, with their spectral shaping serving as a modulation step in the communication scheme.

In at least one embodiment, the communication paradigm is implemented to transmit multiple bits per pulse, for example, by modulating the carrier wave encapsulated within the pulse envelope. In at least one embodiment, the communication paradigm may encode a word, comprising 64 or more bits, within a single pulse for data transmission over the fiber optics communication network.

In at least one embodiment, the communication paradigm can be applied to various optical communication environments, including, but not limited to, fiber optic communication networks, atmospheric and free-space communications, and near-vacuum space communications.

More illustrative information will now be set forth regarding various optional architectures and features with which the foregoing paradigm may be implemented, per the desires of the user. It should be noted that the following information is set forth for illustrative purposes and should not be construed as limiting in any manner. Any of the following features may be optionally incorporated with or without the exclusion of other features described.

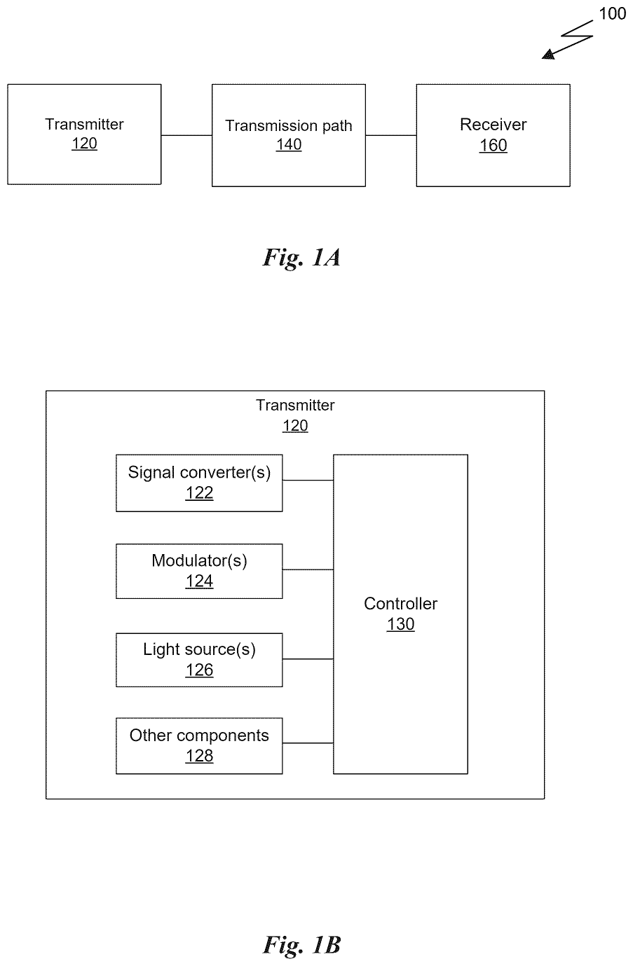

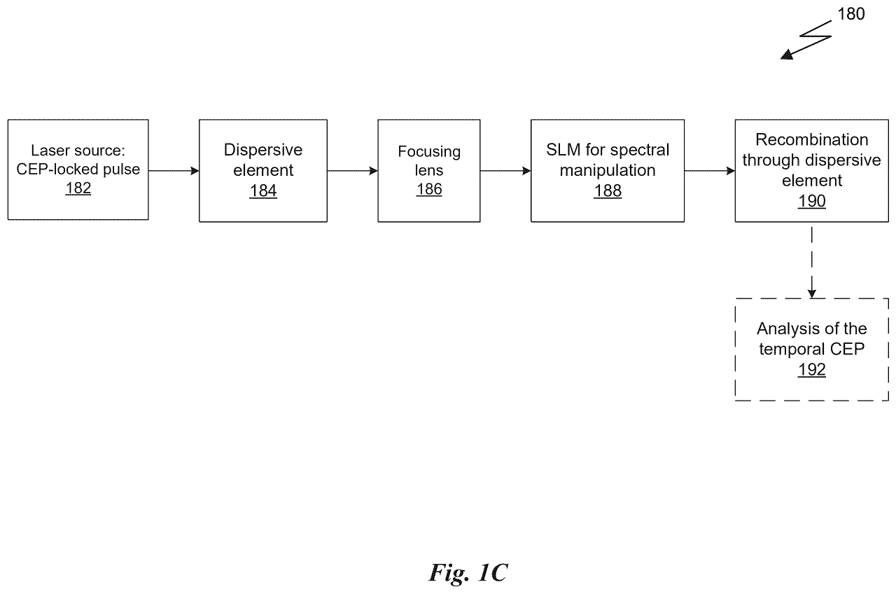

FIG. 1A is a block diagram illustrating a communication system 100, in accordance with one or more embodiments. Each block of system 100, described herein, comprises a process that may be performed using any combination of hardware, firmware, and/or software. For example, various functions may be carried out by a processor executing instructions stored in memory. The system, or one or more components thereof, may be embodied as computer-usable instructions stored on computer storage media. System 100 is described, by way of example, with respect to the system of FIG. 1A. However, this system may additionally or alternatively be executed by any one system, or any combination of systems, including, but not limited to, those described herein. Furthermore, persons of ordinary skill in the art will understand that any system that performs system 100 is within the scope and spirit of embodiments of the present disclosure.

The communication system 100 is configured to transmit data over a suitable medium, such as a fiber optic cable, the atmosphere, or a vacuum. In at least one embodiment, the communication system 100 includes a transmitter 120, a transmission path 140, and a receiver 160. However, it will be understood that the transmitter 120 and/or receiver 160 may be part of a transceiver located at the respective end. Additionally or alternatively, the transmitter 120 and/or receiver 160 may each be a device or system integrated with various functional components, or a standalone device within a larger device or system, such as a terminal device, a relay station, or other suitable component. In at least one embodiment, the transmission path 140 includes one or more optical fiber cables. The optical fibers may be of various types, including, but not limited to, single-mode fibers, multi-mode fibers, or other suitable optical fiber types. In some embodiments, the transmission path 140 includes an optical fiber network. In at least one embodiment, the transmission path 140 involves optical signal propagation in free space, for example, through atmospheric or near-vacuum space.

The transmitter 120 is configured to generate and provide suitable optical signals as input to the transmission path 140. The input to the transmitter 120 may be of various types, including, but not limited to, digital signals, analog signals, electrical signals, and/or optical signals. In some embodiments, the transmitter 120 may include signal conversion components, such as digital-to-analog converters, analog-to-digital converters, or electrical-to-optical converters, to facilitate the transformation of input signals into optical signals compatible with the transmission medium. The transmitter 120 may also perform modulation, encoding, and signal conditioning operations to ensure that the optical signals meet desired performance criteria for transmission over an optical fiber network.

The receiver 160 is configured to receive optical signals transmitted through the transmission path 140. In some embodiments, the receiver 160 includes one or more optical detectors configured to convert the received optical signals into corresponding electrical signals. The receiver 160 may further include additional components such as amplifiers, demodulators, and decoders to process the electrical signals and recover the transmitted data. Signal conditioning, error correction, and synchronization operations may also be performed to enhance signal integrity. The receiver 160 may be implemented as a standalone unit or integrated into a larger system or device within an optical communication network.

FIG. 1B is a block diagram illustrating an example transmitter 120, in accordance with one or more embodiments. Each block of transmitter 120, described herein, comprises a process that may be performed using any combination of hardware, firmware, and/or software. For example, various functions may be carried out by a processor executing instructions stored in memory. Transmitter 120, or one or more components thereof, may be embodied as computer-usable instructions stored on computer storage media. Transmitter 120 is described, by way of example, with respect to the system of FIG. 1B. However, transmitter 120 may additionally or alternatively be implemented by any one system, or any combination of systems, including, but not limited to, those described herein. Furthermore, persons of ordinary skill in the art will understand that any system configured to perform the functions of the transmitter 120 is within the scope and spirit of embodiments of the present disclosure.

As shown in FIG. 1B, the transmitter 120 includes at least one signal converter 122, at least one modulator 124, at least one light source 126, at least one controller 130, and other suitable components 128.

The signal converter 122 is configured to transform input signals, such as electrical, digital, or analog signals, into a form suitable for optical modulation.

The modulator 124 is configured to encode the converted signal onto an optical carrier. The optical carrier is generated by the light source 126, which emits light suitable for optical signal transmission. The modulator 124 encodes the electrical or digital signal onto the optical carrier by varying the properties of the optical field, such as its amplitude, phase, frequency, or polarization. For example, the modulator may operate through amplitude modulation (AM), phase modulation (PM), or frequency modulation (FM). The modulator 124 may be of various types, including a Spatial Light Modulator (SLM). An SLM controls the spatial properties of light, such as its phase or intensity, across a surface (e.g., an optical plane). In some examples, the SLM may use liquid crystal or micromirror arrays to adjust the light. For example, a liquid crystal-based SLM modulates the optical properties of light by applying an electric field to the liquid crystals. This allows the SLM to precisely control the phase or intensity of the optical carrier in specific patterns.

The light source 126 is configured to emit light suitable for optical signal transmission. In at least one embodiment, the light emitted by the light source 126 serves as an optical carrier wave, onto which information may be modulated using techniques such as amplitude, phase, or frequency modulation. The light source 126 may include, for example, a laser diode or another type of light-emitting device, such as a fiber laser, vertical cavity surface emitting laser (VCSEL), or a diode-pumped solid-state laser (DPSSL). The light source may be chosen based on the required wavelength, coherence properties, and power output for the application. In some embodiments, the light source 126 may be phase-locked to another light source or an external reference to maintain precise timing and coherence of the emitted light. Phase-locking refers to the process by which the phase of the emitted light is synchronized with a reference signal, ensuring that the carrier wave maintains a stable phase relationship over time. For example, in systems requiring ultrafast pulsed lasers or coherent light sources, phase-locking may be employed to maintain phase stability, thereby ensuring accurate and consistent performance in various applications. In at least one embodiment, the light source 126 can emit optical signal including a plurality of discrete frequency lines. For example, the light source 126 may be an optical frequency comb, whose spectrum consists of a series of equally spaced, discrete frequency lines, analogous to the teeth of a comb.

In an embodiment, Carrier Envelope Phase (CEP) may be utilized in certain systems, such as ultrafast laser systems. CEP refers to the phase difference between the optical carrier wave and the envelope of the pulse. In the present disclosure, the light source 126 may be configured to operate with a stabilized CEP (or a CEP-locked mode), thereby ensuring that the emitted pulses remain temporally coherent. CEP stabilization may be achieved through feedback mechanisms that lock the CEP to a stable reference, enabling precise control over the temporal characteristics of the pulse train (i.e., the sequence of optical pulses).

Other components 128 may include various optical elements, such as beam steering optics, optical couplers, or nonlinear optical components, which are used to shape and prepare the optical pulses for coupling into a transmission medium (e.g., the transmission path 140). These components may also be used for further frequency manipulation, such as shifting the pulse frequency or bandwidth. Additionally, other components 128 may include electrical components to support signal processing, power management, or feedback control. This architecture enables the transmitter 120 to generate highly customized optical pulses with precise control over their temporal, spectral, and spatial properties.

The controller 130 configured to control the operation of one or more components within the transmitter 120, including, for example, the signal converter 122, the modulator 124, the light source 126, and other suitable components 128. The controller 130 may be implemented in various forms, such as a microcontroller, field-programmable gate array (FPGA), application-specific integrated circuit (ASIC), or a general-purpose processor executing control software.

In some embodiments, the controller 130 is configured to adjust modulation parameters of the modulator 124, such as modulation depth, format, or timing. For example, when the modulator 124 comprises a spatial light modulator (SLM), the controller 130 may control the spatial modulation pattern by applying appropriate voltage levels to individual pixels or elements of the SLM array, thereby adjusting the phase and/or intensity of the modulated optical signal with high precision. In some embodiments, the controller 130 may be configured to tune the emission wavelength or output power of the light source 126. In certain embodiments, the controller 130 may coordinate the timing between the signal converter 122 and the modulator 124 to ensure proper synchronization. In some embodiments, the controller 130 may further interface with one or more feedback systems to maintain phase locking, stabilize the carrier-envelope phase (CEP), or implement adaptive control algorithms that optimize the overall performance of the transmitter 120 in real time.

FIG. 1C is a block diagram illustrating an example optical system 180, in accordance with one or more embodiments. Each block of the optical system 180, described herein, may be implemented by any combination of hardware, firmware, and/or software. In at least one embodiment, the optical system 180 may additionally or alternatively be implemented by any one system, or any combination of systems, including, but not limited to, those described herein. Furthermore, persons of ordinary skill in the art will understand that any system configured to perform the functions of the optical system 180 is within the scope and spirit of embodiments of the present disclosure.

The optical system 180 includes a laser source 182, a dispersive element 184, a focusing lens 186, an SLM 188, and a dispersive element 190 for recombination. In some embodiments, each of the laser source 182, the dispersive element 184, the focusing lens 186, the SLM 188, and/or the dispersive element 190 for recombination may represent one or more respective components. For example, the laser source 182 may may include one or more laser sources, the dispersive element 184 may include one or more dispersive elements, and so on.

The laser source 182 is configured to generate one or more CEP mode locked (or CEP-locked) laser pulses. The dispersive element 184 is an optical component that spatially separates light into its constituent wavelengths (or frequencies). In some examples, the dispersive element 184 may be a prism, a diffraction grating, or another suitable optical component. The focusing lens 186 focuses the spectrally dispersed light onto a plane aligned with the incident surface of the SLM 188. The SLM 188 is configured to spatially modulate the intensity of the different spectral components. The SLM 188 is configured to modulate the intensity of different light components spatially. The dispersive element 190, which may be the same as or different from the dispersive element 184, reverses the spectral dispersion and recombines the light into a single beam.

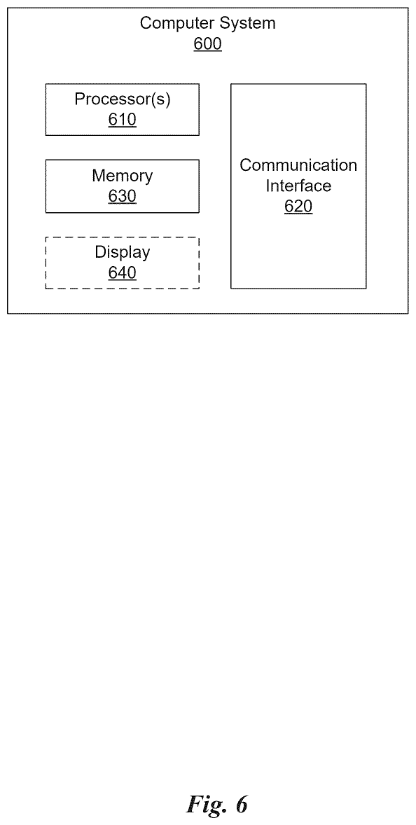

As such, the optical system 180 is configured to generate one or more CEP-locked laser pulses, modulate the CEP-locked laser pulses in the spectral domain, and output the modulated laser pulses in the temporal domain. In at least one embodiment, a suitable computing system (e.g., the computer system 600 as illustrated in FIG. 6) can be employed to perform analysis of the temporal CEP, as illustrated in block 192.

In at least one embodiment, certain components of the optical system 180, such as the laser source 182, the dispersive element 184, the focusing lens 186, the SLM 188, and/or the dispersive element 190 for recombination, may be implemented within the transmitter 120 as illustrated in FIG. 1A or FIG. 1B.

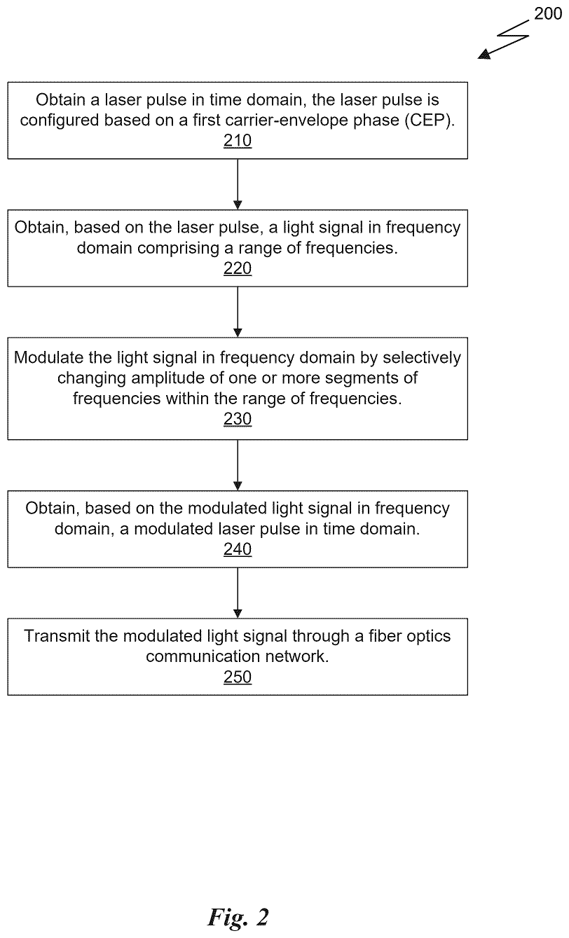

FIG. 2 illustrates a flowchart of a method 200 for data transmission, in accordance with one or more embodiments. Each block of method 200, described herein, comprises a process that may be performed using any combination of hardware, firmware, and/or software. For example, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 is described, by way of example, with respect to the system of FIG. 1A, the device of FIG. 1B, and/or the system of FIG. 1C. However, this method may additionally or alternatively be executed by any one system, or any combination of systems, including, but not limited to, those described herein. Furthermore, persons of ordinary skill in the art will understand that any system that performs method 200 is within the scope and spirit of embodiments of the present disclosure. In at least an embodiment, the communication system 100 of FIG. 1A implements the transmitter 120 of FIG. 1B to perform the method 200.

At stage 210, the transmitter 120 obtains a laser pulse in time domain. The laser pulse is configured based on a first carrier-envelope phase (CEP). The laser pulse may be part of a sequence of pulses (also referred to as a pulse train).

The light source 122 is configured to generate the laser pulse in the time domain. In at least one embodiment, the generation of the laser pulse also involves modulation through one or more modulators 124. The generation and/or modulation of the laser pulse can be controlled by the controller 130.

In at least one embodiment, the light source 122 includes one or more lasers. Lasers used for communication typically meet specific standards related to modulation and frequency range. In the case of wired communication, a specific attention should also be given to fiber coupling to optimize the signal entry in the propagation medium. The frequency bands used for optical communication are commonly near the infrared range. However, shorter wavelengths in the ultraviolet and visible range are used for special applications such as intra and inter-satellite communications. The choice of a specific wavelength depends on the intended application, the required data rate, the type of fiber and the distance over which the signal must be transmitted. For example, lasers with wavelengths of 850 nm may be used for local area networks over short distances; 1310 nm for fiber optic links over short distances; 1550 nm for both fiber optic links and inter-satellite communications over long distances; 1625 nm for fiber optic links over very long distances; 450-490 nm and 650-760 nm for intra-satellite communications over short distances. In other applications, wavelengths in the atmospheric transmission window around 800 nm and 3 microns (μm) would be applicable. For example, wavelengths in the range of 800-4000 nm can be used for short-distance atmospheric communications, while wavelengths in the range of 8000-14,000 nm may be more appropriate for long-distance atmospheric communications.

While 1550 nm is the dominant wavelength used in low-loss, long-haul fiber optic communication-owing to its minimal attenuation in standard optical fibers-mode-locked lasers are also available at other wavelengths, such as 800 nm, 1030 nm, and 1310 nm. These and other alternative wavelengths may open up opportunities for new developments in fiber optic communication, particularly in specialized or short-range applications. At these wavelengths, generating picosecond pulses (ranging from a few to tens of picoseconds) is relatively straightforward and commonly achieved. However, producing femtosecond pulses (under 100 femtoseconds, and as short as a few femtoseconds) is more technically demanding and typically requires advanced laser architectures. Despite the complexity, such ultrashort pulse generation is feasible and can be instrumental for high-speed and high-precision optical communication systems.

The light source 122 may include various types of CEP mode locked lasers, such as gas lasers, solid-state lasers, or semiconductor lasers. In at least one embodiment, the light source 122 includes one or more semiconductor lasers. Semiconductor lasers are compact, reliable, and relatively inexpensive to manufacture. They are also well-suited for optical communication applications because of their high efficiency and ability to modulate output power at high speeds. Semiconductor lasers can be separated into different subcategories based on their structure and operating principles. The three common families of semiconductor lasers used in optical communications are the vertical cavity surface emitting lasers (VCSELs), the distributed feedback lasers (DFBLs) and the Quantumcascade lasers (QCLs). VCSELs are widely used for shortrange wired communications due to their small size, low cost, and ease of integration with fiber optics. DFBLs are suited for long-range communications wired and single mode propagation. QCLs may be used for Free-Space Optics (FSO) applications. Furthermore, QCLs are strongly considered as a possible solution to realize secure wireless optical connections. Continuous wave (CW) lasers emit a constant, uninterrupted beam of light, making it easier to modulate as the light wave properties are responsive to electrical input signals. The light produced by the one or more semiconductor lasers may be modulated to generate the laser pulse in the time domain for further modulation.

In at least one embodiment, the light source 122 includes one or more pulsed lasers. In some embodiments, the pulsed lasers emit high-power light bursts in nanosecond or picosecond durations at repetition rates ranging from a few hertz to several gigahertz. Techniques, such as Q-switching and passive mode-locking, may be used for producing these bursts. In some embodiments, stabilization techniques, such as active stabilization using feedback control loops, or passive stabilization using self-phase modulation, may be utilized to address temperature fluctuations and mechanical vibrations that cause incoherence between pulses. In some embodiments, “pulse locking,” a feedback mechanism, is used to synchronize the output of two independent lasers with a Phase Locked Loop (PLL), adjusting their phases to produce pulses with a stable phase relationship.

In at least one embodiment, the pulses generated at stage 210 have a fixed delay and coherent phase relationship. This enables the combination of outputs from two separate lasers to achieve coherent pulse generation. For example, pulse locking can be used to generate stable, high-quality pulses with precise phase relationships. To generate ultrashort laser pulses with repeatable coherent phase, distinct frequency modes of light must be phase synchronized not only with each other, but also with the pulse's electromagnetic field envelop. The pulse's electromagnetic field envelop is referred to as carrier-envelope phase (CEP).

In at least one embodiment, a pulse train can be emitted with coherent phases across the pulses, enabling precise phase control and modulation.

At stage 220, the transmitter 120 obtains, based on the laser pulse, a light signal in frequency (or spectral) domain. The light signal includes a range of frequencies. For example, suitable components, such as those included in the other components 128 or the dispersive element 184 in FIG. 1C, may be used to transform the laser pulse from the time domain into a light signal in the frequency domain. In at least one embodiment, the transformation is facilitated by Fourier optics, including optical lenses. In at least one embodiment, the optical components, such as the dispersive element 184 and/or the focusing lens 186 in FIG. 1C, are used to transform the time domain light into the frequency domain. In some embodiments, in the frequency domain, the light signal, including a range of frequencies, is represented as a spatial distribution of its constituent frequency components.

At stage 230, the transmitter 120 modulates the light signal in the frequency domain by selectively modulating one or more segments of frequencies within the range of frequencies. For example, the modulation may be achieved by changing amplitude of the one or more segments of frequencies. In at least one embodiment, at least one modulator 124, such as an SLM, is used to selectively dim or highlight specific frequency segments of the pulses. In some embodiments, the SLM modulates a light signal in the frequency domain by dynamically controlling the phase and amplitude of the light at different spatial locations (e.g., pixels). In some embodiments, a controller 130 transmits electrical signals to the SLM, which converts these signals into corresponding changes in the light's spatial properties, effectively shaping the spectrum of the light (or light signal). By adjusting the SLM's pixels, the frequency components of the light can be selectively manipulated, allowing for precise control over the light's spectrum.

In at least one embodiment, a modulator 124 is configured to selectively block certain frequencies (or frequence segments) to modulate the light signal in the frequency domain.

In at least one embodiment, the light signal is modulated according to patterns predefined to represent a word from among a plurality of predefined words. In other words, the light signal can be encoded in the frequency domain to carry multiple bits of information per pulse, such as a 64-bit word. This approach differs from complex multiplexing techniques like Optical Code Division Multiple Access (OCDMA), which rely on intricate coding schemes to enable signal separation and access.

In at least one embodiment, the modulation performed at stage 230 may implement coherent modulation, which enables enhanced data rates by encoding information in both the amplitude and phase of the optical signal. Coherent modulation allows for more efficient use of bandwidth and supports advanced modulation formats. At the receiver end (e.g., the receiver 160), coherent demodulation, often in conjunction with digital signal processing (DSP), facilitates accurate data recovery, even in the presence of noise and signal distortions. DSP can further compensate for transmission impairments and optimize spectral efficiency. This combination of coherent modulation and DSP significantly increases the capacity of optical communication systems by enabling the use of more complex modulation formats.

At stage 240, the transmitter 120 obtains, based on the modulated light signal in the frequency domain, a modulated laser pulse in the time domain. For example, the other components 128 in the transmitter 120 are used to transform the modulated light signal from the frequency domain into a modulated laser pulse in the time domain. In at least one embodiment, the dispersive element 190 for recombination in FIG. 1C is used to recombine the dispersed light in the frequency domain to produce the recombined light beam in the time domain. As will be discussed hereafter, the modulated laser pulse preserves the initial CEP (e.g., the first CEP) of the laser pulse generated at stage 210.

At stage 250, the transmitter 120 transmits the modulated light signal through a fiber optics communication network. For example, the transmitter 120 transmits the modulated light signal into the transmission path 140.

In at least one embodiment, the pulse (or the pulse train) processed using method 200 corresponds to a CEP and is associated with a single user. In some embodiments, method 200 is performed to generate a plurality of pulse trains for transmission in a communication network (e.g., within a single fiber or across multiple fibers in a fiber optic network, through atmospheric channels, or in other suitable communication environments). Each of these pulse trains has a specific CEP. In at least one embodiment, a particular CEP may be assigned to a single user's pulse trains, and this CEP can be dynamically changed or “swapped” as needed. The pulse trains may be associated with one user or distributed among multiple users.

In at least one embodiment, semiconductor CEP mode-locking technology is implemented to generate optical signals with stabilized CEP. In at least one embodiment, one or more spatial light modulators (SLMs) are used for pulse shaping.

In at least one embodiment, an encoding paradigm is provided, leveraging the CEP of CEP-locked ultrashort laser pulses. The encoding paradigm may be implemented in the communication system 100 as demonstrated in FIG. 1A, the transmitter 120 as shown in FIG. 1B, and/or the optical system 180 as illustrated in FIG. 1C. In at least one embodiment, the encoding paradigm is based on spectral manipulation of CEP-locked ultrashort laser pulses to selectively block and/or manipulate some frequencies to modulate the signal. This is different from traditional modulation techniques used in CW lasers modulation. This approach harnesses the broad bandwidth offered by ultrashort pulses for efficient data transmission.

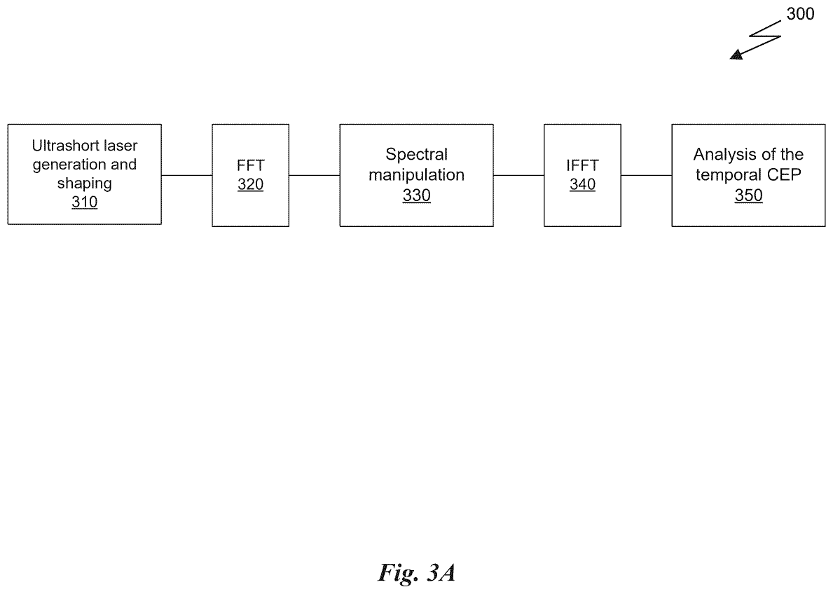

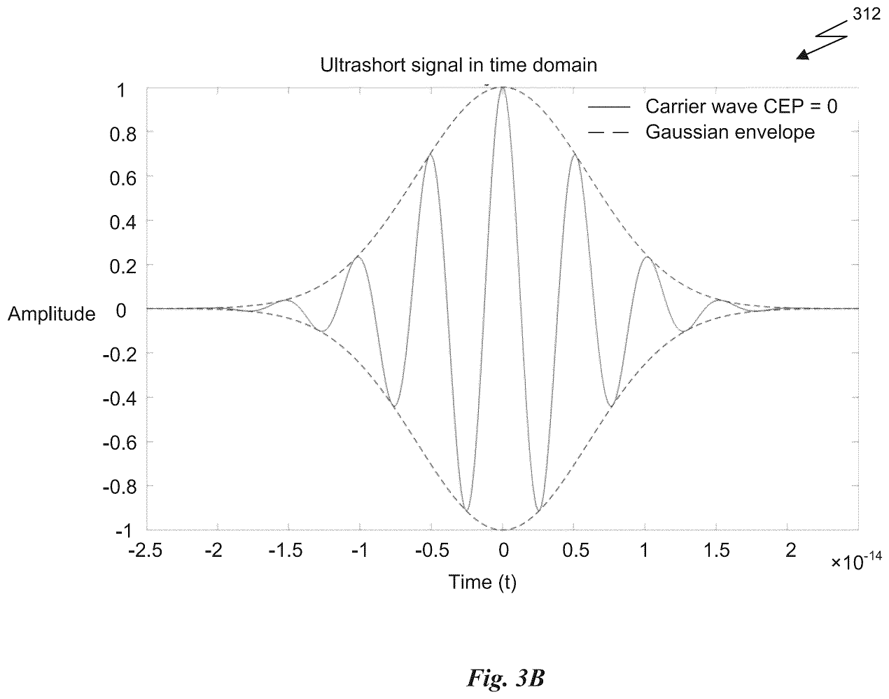

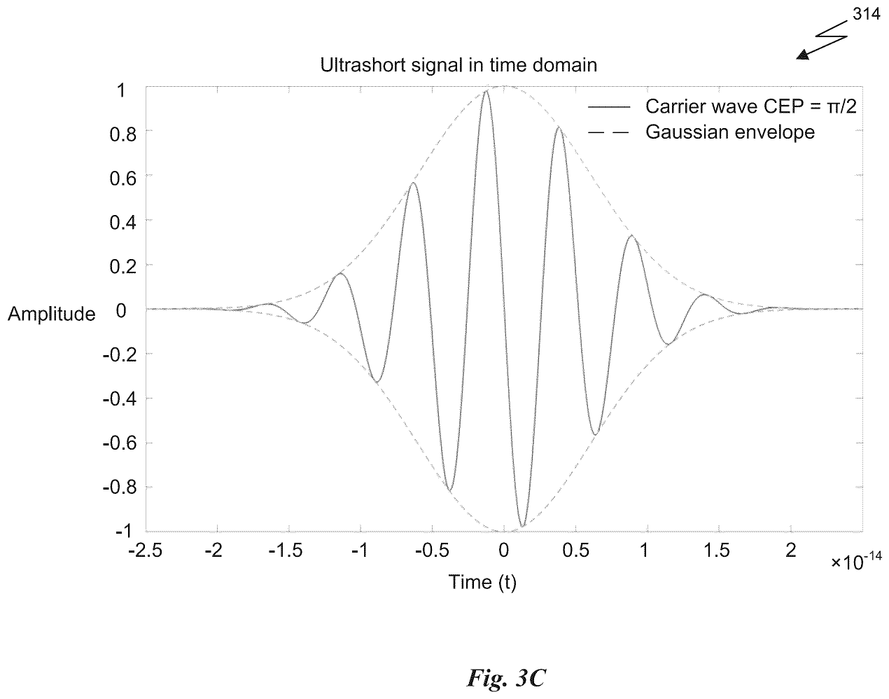

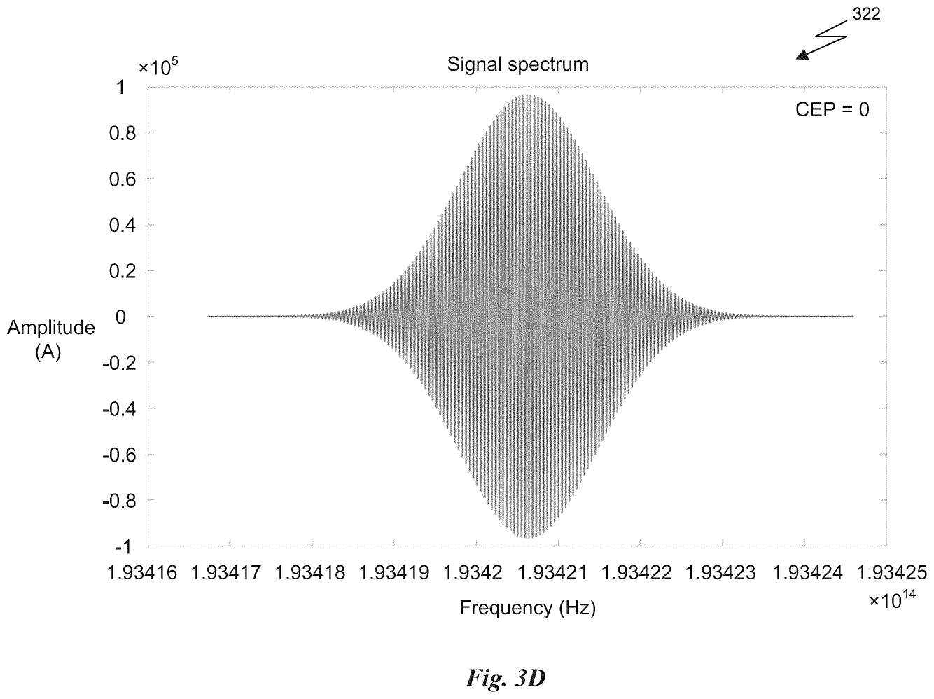

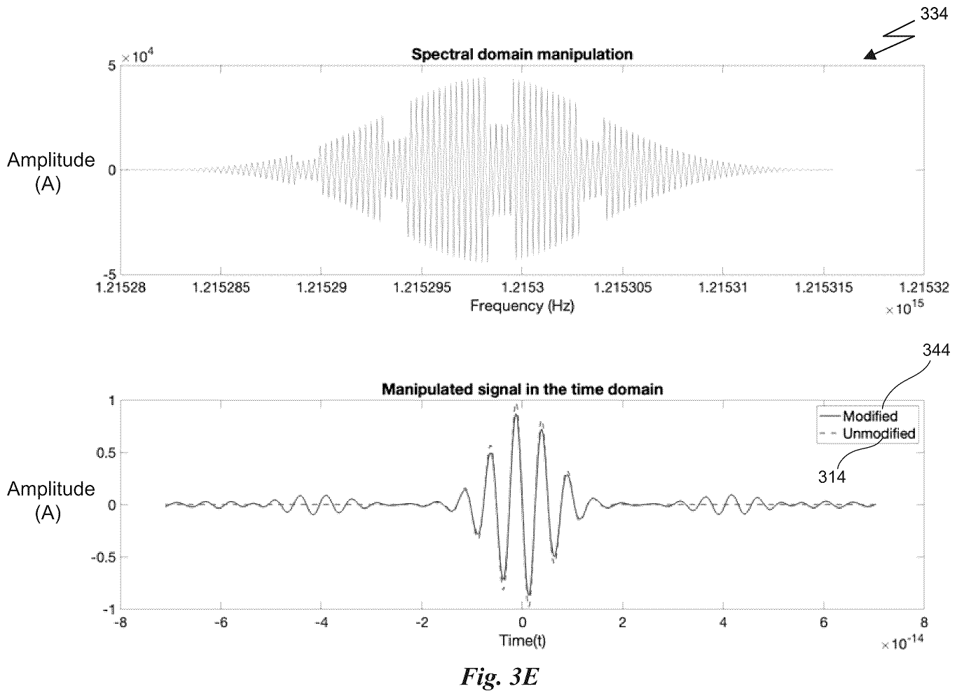

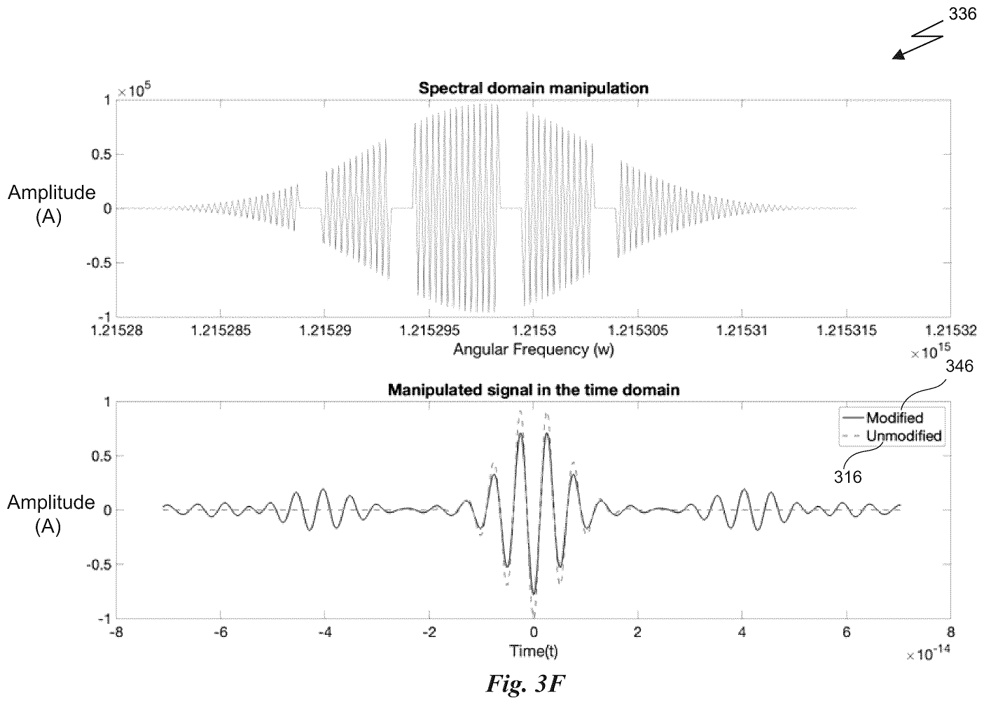

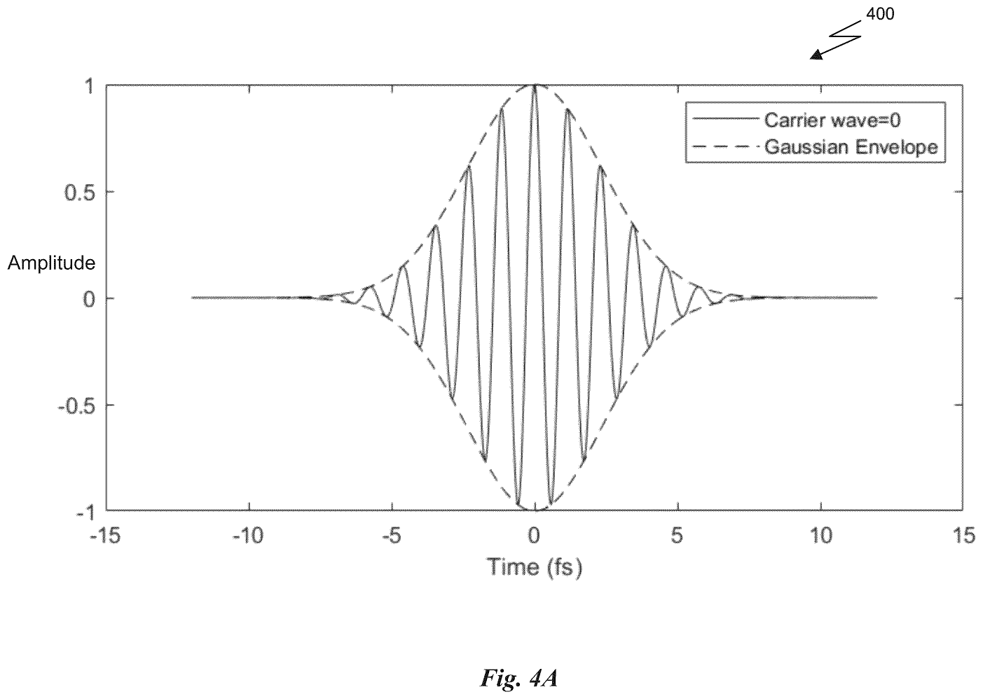

FIG. 3A illustrates a flow diagram illustrating a method 300 for modeling signal modulation, in accordance with one or more embodiments. Each block of method 300, described herein, comprises a process that may be performed using any combination of hardware, firmware, and/or software. For example, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with reference to a device that models the device, or components thereof, as shown in FIG. 1B. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At block 310, at least one ultrashort laser pulse is generated and shaped in time domain. For example, an ultrashort laser pulse is provided with a Full Width Half Maximum (FWHM) of 10 femtoseconds (fs) and a central wavelength of 1550 nanometers (nm).

FIG. 3B illustrates an example laser pulse 312 in the time domain, in accordance with one or more embodiments. The laser pulse 312 is depicted in the time domain (also referred to as the temporal domain), representing the evolution of the electromagnetic field (or optical field) over time. The solid line in the figure denotes the carrier waveform, which is an oscillating electromagnetic field at the optical frequency. The dashed line represents the pulse envelope, which describes the overall intensity profile of the pulse. In this example, the envelope follows a Gaussian shape, indicating that the pulse energy is temporally confined and symmetrically distributed around its peak. In this case, CEP is zero, as the peak of the carrier waveform aligns with the peak of the envelope, resulting in a maximally constructive field at the pulse center. In some embodiments, the laser pulse obtained at block 310 have other values for the CEP, such as π, π/2, or other values. FIG. 3C illustrates an example laser pulse 314 in the time domain, where CEP is π/2.

In at least one embodiment, in the time domain, the ultrashort optical (or laser) pulse (E(t)) is represented by:

$$E ( t ) = \hat{A} ( t ) exp [ i ( {ω}_{0} t - ϕ ( t ) ) ] , \qquad ( Eq . 1 )$$

where A(t) represents the amplitude of the pulse, ω₀ represents the central frequency of the pulse, and ϕ(t) represents a phase element corresponding to difference between the carrier and the peak of the CEP. In some embodiments, the amplitude (A(t)) of the pulse follows a Gaussian shape. The amplitude may be quantified using the full-width half maximum (FWHM) duration, generally expressed as τ, which characterizes the pulse's amplitude profile. There are two elements in the phase term, including ω₀ and ϕ(t). ω₀ defines the pulse's central frequency, pinpointing the spectral center of the pulse. ϕ(t) represents how the phase of the carrier wave aligns with the peak of the CEP (e.g., the Gaussian envelope). Together, both elements within the phase term describe the temporal properties of an ultrashort optical pulse.

At block 320, the laser pulse is transformed into a light signal in frequency domain using Fast Fourier Transform (FFT). As such, the temporally shaped pulse is converted into a spectrally distributed light signal. This process enables controlled changes to the spectral content (e.g., constituent frequency components) of the pulses.

FIG. 3D illustrates an example signal spectrum 322 in the frequency domain, in accordance with one or more embodiments. In this example, the CEP associated with the light signal is zero.

In at least one embodiment, in the frequency domain, the light signal is represented by:

$$E ( ω ) = A ( ω ) exp [ - i ϕ ( ω - {ω}_{0} ) ] , \qquad ( Eq . 2 )$$

where the function ϕ(ω-ω₀) represents the CEP in the frequency domain.

At block 330, the light signal in the frequency domain is manipulated through its constituent frequency components. In at least one embodiment, one or more discrete frequency components of the pulse are selectively manipulated. In at least one embodiment, one or more segments within the frequency range of the light signal are selectively modified. This enables the modeling of symbol encoding.

FIG. 3E illustrates an example plot 334 of a manipulated signal spectrum in the frequency domain, in accordance with one or more embodiments. As shown in the frequency domain plot 334, several segments within the frequency range of the pulse are blocked.

At block 340, the manipulated light signal in the frequency domain is transformed into a manipulated ultrashort laser pulse in the time domain. Inverse Fast Fourier Transform (IFFT) function may be utilized to revert the manipulated light signal to the time domain.

At block 350, the manipulated ultrashort laser pulse in the time domain is analyzed.

In some embodiments, implications of manipulating the spectrum of ultrashort pulses are explored, considering both temporal and broader domain effects. The implications encompass various aspects, including the modulation achieved through the selective retention and exclusion of specific frequency components.

FIG. 3E also illustrates the manipulated ultrashort laser pulse 344 in the time domain, in accordance with one or more embodiments. In FIG. 3E, the manipulated ultrashort laser pulse 344 is compared, in the time domain, with a corresponding ultrashort laser pulse 314 generated at block 310 (and shown in FIG. 3C). Both the pulse 344 and the pulse 314 are associated with a CEP of π/2.

FIG. 3F illustrates another example plot 336 of a manipulated signal spectrum in the frequency domain and another example manipulated ultrashort laser pulse 346 in the time domain, in accordance with one or more embodiments. In FIG. 3F, several segments within the frequency range of the pulse 336 are blocked. Additionally, the manipulated ultrashort laser pulse 346 is compared, in the time domain, with a corresponding ultrashort laser pulse 316 generated at block 310. Both the pulse 346 and the pulse 316 are associated with a CEP of T.

FIGS. 3E and 3F demonstrate the impact of spectral manipulation on ultrashort optical pulses, resulting in significant alterations in spectral characteristics and amplitude reduction within the pulse's envelope. Notably, despite spectral manipulations, the CEP remains unchanged, serving as a stable reference point within the pulse's waveform.

This resilience of the CEP aligns with theoretical equations describing temporal and spectral attributes. For example, Equation 1 illustrates the temporal evolution of ultrashort pulses, highlighting the interplay between amplitude, central frequency, and phase. On the other hand, Equation 2 translates this information into the frequency domain, encapsulating the behavior of the CEP through spectral components. The steadfastness of the CEP in response to spectral manipulation resonates with the theoretical framework, affirming its fundamental resilience as a hallmark of ultrashort pulse characteristics. This consistency not only provides insight into the pulse's behavior but also offers a dependable detection mechanism for compensation development and discerning intrusive attempts.

Additionally, dispersive behavior of ultrashort pulses are analyzed.

In the realm of light signal transmission, whether dealing with ultrashort or conventional light signals, dispersion occurs inevitably as the signal traverses through the medium. For the design of a highly efficient communication system, it is paramount to obtain a comprehensive grasp of how dispersion influences the signal's behavior. The communication paradigm herein uses the CEP to assess and quantify dispersion effects in ultrashort CEP mode-locked signals. In this regard, CEP functions as a key parameter for maintaining coherence and ensuring the reliability of the disclosed communication approach. Moreover, factors such as transmission distance and optical fiber characteristics are taken into account to determine a suitable dispersion compensation strategy. In at least one embodiment, the communication paradigm implements algorithms to mitigate dispersion-induced on the signal by using DSP techniques. Additionally and/or alternatively, the compensation to the pulse at the receiver end can be facilitated by hardware based solutions, for example, utilizing components in the receiver 160.

Recent insights into tapping techniques have exposed vulnerabilities in fiber optics communication systems. Fiber tapping typically employs network tap methods that allow for the extraction of optical signals without physically severing or disrupting the fiber connection. For example, such techniques may be used for lawful network monitoring or diagnostics; however, they can also be exploited for unauthorized interception. These methodologies exploit weaknesses in the infrastructure, raising security concerns about data confidentiality. Tapping methods, both intrusive and non-intrusive (e.g., fiber bending, optical splitting, evanescent coupling, scattering), complicate detection. Safeguarding against unauthorized access involves cable surveillance, signal monitoring, and high bend fibers. Encryption, the last defense, renders intercepted data unintelligible to unauthorized entities. However, the advent of quantum computing poses a formidable threat to conventional encryption methods. To prevent this, post-quantum cryptography is actively researched, offering a more robust approach to encryption. Quantum key distribution (QKD) provides unbreakable encryption keys but is limited to quantum technology resources. In a broader context, post-quantum cryptography presents a versatile solution to mitigate threats. However, a layered security approach, combining various security measures, remains crucial in this transitional period.

The present disclosure leverages the carrier envelope phase (CEP) sensitivity. The CEP of a femtosecond CEP mode-locked laser refers to the phase difference between the electromagnetic field of the laser's carrier wave and the envelope of the wave.

The stability of transmission distance and optical fiber properties, when left undisturbed, can be a valuable asset in enhancing the security of the communication paradigm. In essence, any deviation beyond the expected dispersion can act as a trigger or alarm for detecting malicious fiber tampering (intrusive and non-intrusive). As such, the communication paradigm herein establishes a reference point for normal system behavior, by continuously monitoring the CEP of ultrashort laser pulses and comparing it to a baseline of anticipated dispersion characteristics. Significant deviations from this baseline would then indicate possible interference or tampering, providing an early warning for the communication system against unauthorized access or disruptions. This proactive security layer could not only safeguards data transmission but also fortifies the overall resilience of the communication framework.

The following discussion presents a framework that builds upon Equations 1 and 2 and establishes a connection between the CEP and the carrier wave. In at least one embodiment, Equation 2 may be rewritten to take into account the propagation distance. For example, the electric field of an ultrashort laser pulse at a distance (z) from the sender (e.g., the transmitter 120) can be expressed as:

$$E ( ω , z ) = \hat{E} ( ω ) exp [ - i ϕ ( ω , z ) ] \qquad ( Eq . 3 )$$

where Ê(ω) is the Gaussian envelope that modulate the periodic wave ϕ(ω, z). In the context of light propagation, amplitude (A) and electric field (E) are related concepts. For ease of understanding, the framework is described in terms of the electric field (E). The Gaussian envelope is given by:

$$\hat{E} ( ω ) = \frac{{E}_{0} {τ}_{0}}{\sqrt{ln 2}} exp [ - \frac{{( ω - {ω}_{0} )}^{2} {τ}_{0}^{2}}{8 ln 2} ] , \qquad ( Eq . 4 )$$

where ω₀ is an optical frequency located at the center of the ultrashort laser pulse, and ω is angular frequency. Equation 4 represents the Gaussian envelope containing an FWHM of τ₀ with an amplitude crest (E₀) that occurs at the optical frequency (ω₀).

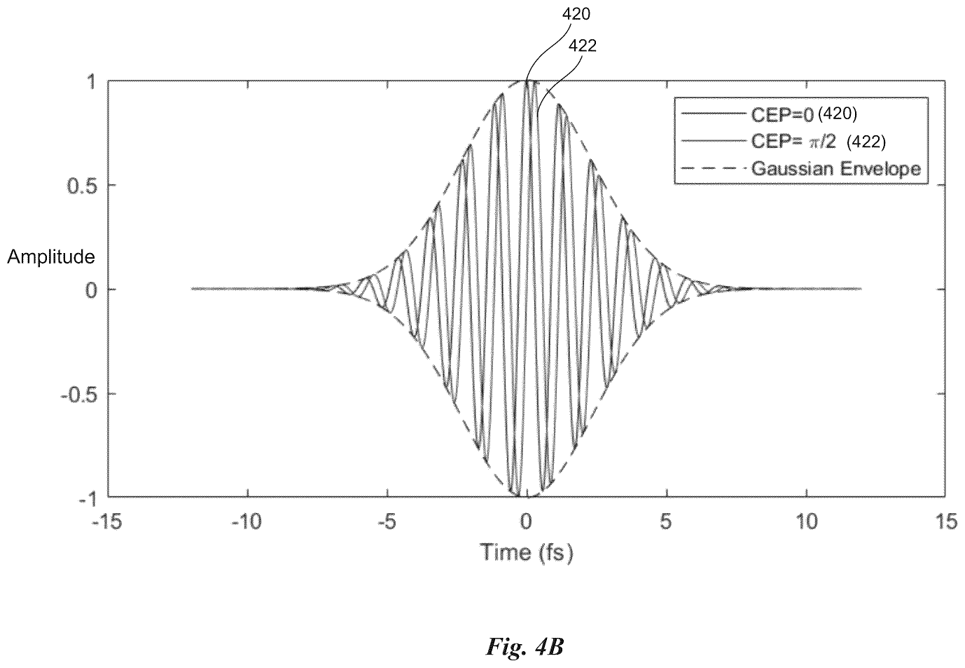

FIG. 4A illustrates an example electrical field wave 400, in accordance with an embodiment. The electrical field wave 400 is associated with the optical frequency (ω₀). In FIG. 4A, the solid line represents the carrier waveform, which is an oscillating electromagnetic field at the optical frequency. The dashed line represents the pulse envelope, which describes the overall intensity profile of the pulse. In this example, the envelope follows a Gaussian shape with a CEP of zero.

In Equation 3, the function ϕ(ω, z) is a function of the angular frequency (Ω) and the distance (z) that the pulse has traveled from its origin. As the pulse propagates through the optical medium, it undergoes dispersion and other effects that cause the phase to vary with frequency and distance.

The CEP is defined as the relative phase difference between the carrier wave and the pulse envelop. The CEP is typically expressed in radians and have values ranging form 0 to 2π. FIG. 4B illustrates an example pulse shift, in accordance with an embodiment. In FIG. 4B, a pulse 420 with a CEP set to zero is shifted to a pulse 422 with a CEP set to

$$\frac{π}{2} .$$

The CEP plays an important role on the waveform phase as it propagates through the medium. The case of CEP can be generalized for measuring the phase difference (Δϕ_{ω}_{ᵢ}) between the pulse envelope and any of the contained wave spectral components with an optical frequency (ωᵢ). The phase difference is expressed as:

$${Δϕ}_{{ω}_{i}} = ϕ ( {ω}_{i} , z ) - GD \times {ω}_{i} , \qquad ( Eq . 5 )$$

where GD is group delay that represents the time delay experienced by the group of waves centered around the carrier frequency as they propagate a unit distance through the medium. Equation 5 describe the spectral phase function of the i^{th} wave component with optical frequency (ωᵢ), which is denoted by Δφ_{ω}_{ᵢ}. The spectral phase function characterizes the frequency-dependent phase shift experienced by the i^{th} wave component as it propagates through the medium. The special case of the carrier wave, when i=0 in Equation 5, corresponds to the CEP.

Both Δϕ_{ω}_{ᵢ} and GD can be computed from the Taylor expansion using the spectral phase component, which involves the first, second, and third partial derivatives of Δϕ_{ω}_{ᵢ} with respect to w evaluated at ω₀:

$$ϕ ( ω , z ) = ϕ ( {ω}_{0} , z ) + \frac{\partial ϕ ( ω , z )}{\partial ω} {\vert}_{ω = {ω}_{0}} ( ω - {ω}_{0} ) + \frac{1}{2 !} \frac{{\partial }^{2} ϕ ( ω , z )}{{\partial }^{2} ω} {\vert}_{ω = {ω}_{0}} {( ω - {ω}_{0} )}^{2} + \frac{1}{3 !} \frac{{\partial }^{3} ϕ ( ω , z )}{{\partial }^{3} ω} {{\vert}_{ω = {ω}_{0}} ( ω - {ω}_{0} )}^{3} + … . \qquad ( Eq , 6 )$$

Specifically, ϕ(ω₀, z) can be derived from the first term of the Taylor expansion, which simplifies to:

$$ϕ ( {ω}_{0} , z ) = \frac{{ω}_{0} \times n ( {ω}_{0} ) \times z}{C} , \qquad ( Eq . 7 )$$

where n(ω₀) is the refractive index as a function of medium conductivity. In at least one embodiment, GD can be obtained from the first derivative of ϕ(w,z) with respect to the central or carrier frequency of the ultrashort laser pulse (ω₀), as:

$$GD = \frac{\partial ϕ ( ω , z )}{\partial ω} {\vert}_{ω = {ω}_{0}} . \qquad ( Eq . 8 )$$

Equation 6 is the Taylor expansion of the phase of an ultrashort laser pulse in terms of its carrier frequency (ω) and the propagation distance (z). This equation expresses the phase (ϕ(ω, z)) as a sum of terms of increasing order in (ω-ω₀), where ω is the current value of ω and ω₀ is the carrier frequency.

As such, a connection is established between two physically-invariant metrics of phase shift for a stabilized ultrashort laser pulse: the CEP and the fiber propagation properties for the carrier wave frequency. With modern stabilized ultrashort laser sources, it is possible to choose and control the CEP. By using the CEP as a reference to compensate for the influence of fiber dispersion on the carrier wave, coherence can be ensured between the emitted and received signals despite the dispersion properties of the fiber. The amount of dispersion depends on both the distance traveled by the pulse and the characteristics of the fiber. However, by carefully controlling the CEP, the coherence of the signal is maintained and achieve high-speed communication with high bandwidth and low latency.

In some embodiments, changes in the CEP during uninterrupted fiber transmission are evaluated using Equations 1-8, providing a baseline for detecting unexpected variations and thereby enhancing network security.

For example, two separate simulations are presented. The first simulation calculates the estimation of the phase shift (Δϕ_{ω}_{ᵢ}) for different distances traveled, where the distances are measured between two large cities as viewed from a bird's eye perspective. This simulation is based on the Equations 5 and 6 discussed above. The second simulation focuses on the additional shift induced by tapping, with various tapping lengths being evaluated to determine the accuracy of the model. In the simulations, a wavelength of 1550 nm was used as it is optimal for long haul communication. The pulse repetition rate was set at 46 MHz, while the pulse duration was set to 14 femtoseconds (fs). For standard single-mode fibers (SMF) used in long-haul communication typically have a refractive index of around 1.45-1.48 at a wavelength of 1550 nm. In the simulations, the refractive index was set to 1.45.

In communication systems, the dispersion of media can cause a shift in the pulses, ranging from zero to 21. Table 1 demonstrates that different distances require different compensation. In Table 1, phase shifts between two large cities are presented. The phase shift is not strictly proportional to the distance due to the periodic nature of the phase. The simulation results, such as those presented in Table 1, can be used to determine appropriate compensations to apply at the receiver. Compensation techniques, either hardware- or software-based, can be used to minimize the effects of dispersion and maintain signal integrity. In some embodiments, phase correction may be achieved using algorithms and/or photonic structures, which are derived by correlating simulation data with experimental measurements.

TABLE 1
Phase shift (Δϕ_{ω}_{₀}) induced by the distance traveled.

| Distance (Km) | Δϕ (rad) | Δϕ(°) |
|---|---|---|
| Lincoln/Chicago 848.76 | −1.50 | −85.94 |
| New York/London 5570.31 | 1.08 | 61.82 |
| Paris/London 342.76 | 0.48 | 27.44 |
| San Francisco/Tokyo 8270.3 | 2.44 | 139.67 |
| Seattle/New York 3865.3 | 1.89 | 108.05 |

As discussed above, tapping equipment can increase the dispersion of fiber optic cables, which in turn results in an increase in the absolute distance traveled by the signal. The additional distance depends on the tapping method employed, with techniques ranging from elevating a few centimeters to several hundred meters. In the second simulation, distances ranging from 10 to 2000 kilometers were considered to evaluate the possibility of detecting the extra phase shift induced by tapping. Tapping approaches of different sizes were simulated, including 10 cm, 1 meter (m), 10 m, 25 m, and 50 m. By accurately predicting the additional phase shift introduced by tapping, the communication system 100 (e.g., at the receiver 160) may recognize and detect intrusion attempts in a communication link, thereby significantly enhancing security.

Table 2 shows the difference between the expected and actual phase shifts, in accordance with an embodiment. The difference can be used to detect intrusion attempts. A mismatch between the expected and actual phase shifts indicates tampering with the signal, serving as an effective intrusion detection method. Additionally, the use of femtosecond lasers introduces uncertainty into the tapping process, and physical tapping is only accessible to rare uncovered areas of the fiber cable. Even if tapping is successful, the attacker lacks critical information such as the current communication CEP and the distance from the origin. Rendering exact deciphering extremely challenging. Therefore, discrepancies in phase shifts due to tapping can serve as a powerful detection measure while the use of assigned (that could be regularly changed to increase security) CEP as a reference could act as a tool that leads to confusion in deciphering the signal.

TABLE 2
Additional phase shift (Δϕ_{ω}_{₀}) induced by tapping.

| Distance (Km) | Tapping (m) | Δϕ (rad) | Δϕ(°) |
|---|---|---|---|
| 10 | 0.1 | 2.01 | 115.36 |
| | 1 | 1.28 | 73.62 |
| | 10 | 0.28 | 16.17 |
| | 25 | 0.71 | 40.43 |
| | 50 | 1.41 | 80.87 |
| 500 | 0.1 | 2.01 | 115.36 |
| | 1 | −5.00 | −286.38 |
| | 10 | 0.28 | 16.20 |
| | 25 | 0.71 | 40.46 |
| | 50 | −4.87 | −279.11 |
| 1000 | 0.1 | 2.01 | 115.36 |
| | 1 | 1.29 | 73.65 |
| | 10 | 0.28 | 16.20 |
| | 25 | 0.71 | 40.46 |
| | 50 | 1.41 | 80.92 |
| 2000 | 0.1 | 2.01 | 115.36 |
| | 1 | −5.00 | −286.30 |
| | 10 | 0.28 | 16.25 |
| | 25 | −5.58 | −319.54 |
| | 50 | −4.87 | −279.08 |

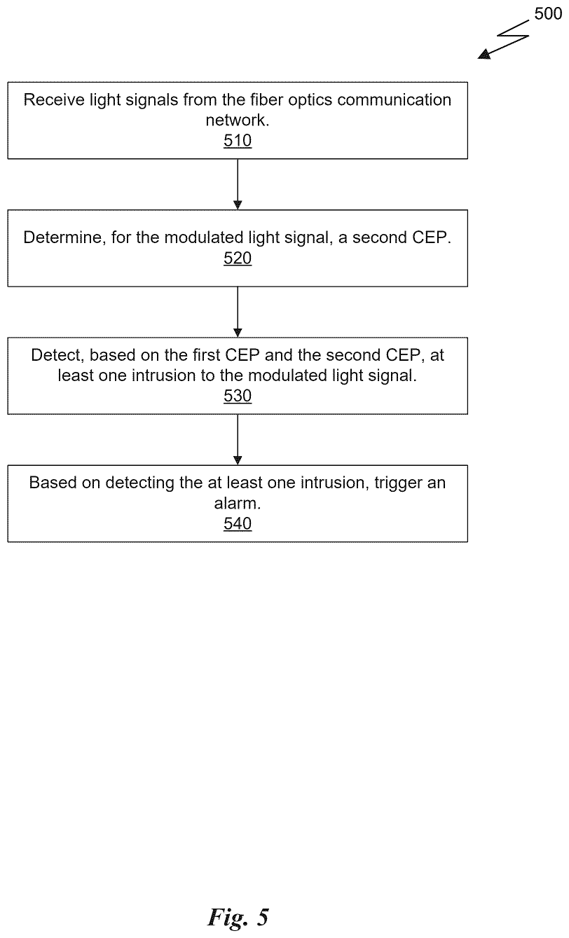

FIG. 5 illustrates a flowchart of a method 500 for detecting intrusion, in accordance with one or more embodiments. Each block of method 500, described herein, comprises a process that may be performed using any combination of hardware, firmware, and/or software. For example, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the system of FIG. 1A and/or the receiver 160 therein. However, this method may additionally or alternatively be executed by any one system, or any combination of systems, including, but not limited to, those described herein. Furthermore, persons of ordinary skill in the art will understand that any system that performs method 500 is within the scope and spirit of embodiments of the present disclosure.

At the stage 510, the receiver 160 receives light signals from the fiber optics communication network. For example, the receiver 160 receives one or more modulated light signals generated by the transmitter 120 (e.g., by performing method 200), which propagates through the transmission path 140. The light signals are generated with a first CEP.

At the stage 520, the receiver 160 determines, for the light signals, a second CEP. For example, the receiver 160 determines the CEP of the received light signal as the second CEP.

At the stage 530, the receiver 160 detects, based on the first CEP and the second CEP, at least one intrusion to the modulated light signal. In at least on embodiment, the receiver 160 determines a phase shift based on the first CEP and the second CEP and compares the phase shift with a reference. In at least one embodiment, one or more correspondence tables are used to store reference phase shift values corresponding to parameters related to the transmission path (e.g., distance and characteristics of the transmission medium). However, it should be noted that other suitable data structures, such as lists, databases, or lookup arrays, may also be used to store these reference values. In at least one embodiment, the correspondence tables or alternative data structures can be stored in any component of the communication system 100. These storage arrangements may be centralized, distributed across multiple components, or implemented in a hybrid (combined) manner depending on system design and operational requirements.

At the stage 540, the receiver 160 triggers an alarm based on detecting the at least one intrusion.

FIG. 6 is a block diagram illustrating a computer system 600 configured to implement various functions, in accordance with one or more embodiments. Each block of computer system 600, described herein, comprises a computing process that may be performed using any combination of hardware, firmware, and/or software. For example, various functions may be carried out by a processor executing instructions stored in memory. The system, or one or more components thereof, may be embodied as computer-usable instructions stored on computer storage media. This system may additionally or alternatively be executed by any one system, or any combination of systems, including, but not limited to, those described herein. Furthermore, persons of ordinary skill in the art will understand that any system that performs computer system 600 is within the scope and spirit of embodiments of the present disclosure.

In some embodiments, the computer system 600 is integrated with or coupled to the transmitter 120 and/or the receiver 160, as shown in FIG. 1A or 1B, and/or the optical system 180 in FIG. 1A.

As shown in FIG. 6, the computer system 600 may include one or more processors 610, a communication interface 620, a memory 630, and optionally a display 640. The processor(s) 610 may be configured to perform the operations in accordance with the instructions stored in the memory 630. The processor(s) 610 may include any appropriate type of general-purpose or special-purpose microprocessor (e.g., a CPU or GPU, respectively), digital signal processor, microcontroller, or the like. The memory 630 may be configured to store computer-readable instructions that, when executed by the processor(s) 610, can cause the processor(s) 610 to perform various operations disclosed herein. The memory 630 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), a flash memory, a dynamic random-access memory (“RAM”), and/or a static RAM. Various processes/flowcharts described in terms of mathematics in the present disclosure may be realized in instructions stored in the memory 630, when executed by the processor(s) 610.

The communication interface 620 may be configured to communicate information between the computer system 600 and other devices or systems. For example, the communication interface 620 may include an integrated services digital network (“ISDN”) card, a cable modem, a satellite modem, or a modem to provide a data communication connection. As another example, the communication interface 620 may include a local area network (“LAN”) card to provide a data communication connection to a compatible LAN. As a further example, the communication interface 620 may include a high-speed network adapter such as a fiber optic network adaptor, 10G Ethernet adaptor, or the like. Wireless links can also be implemented by the communication interface 620. In such an implementation, the communication interface 620 can send and receive electrical, electromagnetic or optical signals that carry digital data streams representing various types of information via a network. The network can typically include a cellular communication network, a Wireless Local Area Network (“WLAN”), a Wide Area Network (“WAN”), or the like.

The communication interface 620 may also include various I/O devices such as a keyboard, a mouse, a touchpad, a touch screen, a microphone, a camera, a biosensor, etc. A user may input data to the computer system 600 through the communication interface 620.

The display 640 may be integrated as part of the computer system 600 or may be provided as a separate device communicatively coupled to the computer system 600. The display 190 may include a display device such as a liquid crystal display (“LCD”), a light emitting diode display (“LED”), a plasma display, or any other type of display, and provide a graphical user interface (“GUI”) presented on the display for user input and data depiction. In some embodiments, display 640 may be integrated as part of the communication interface 620.

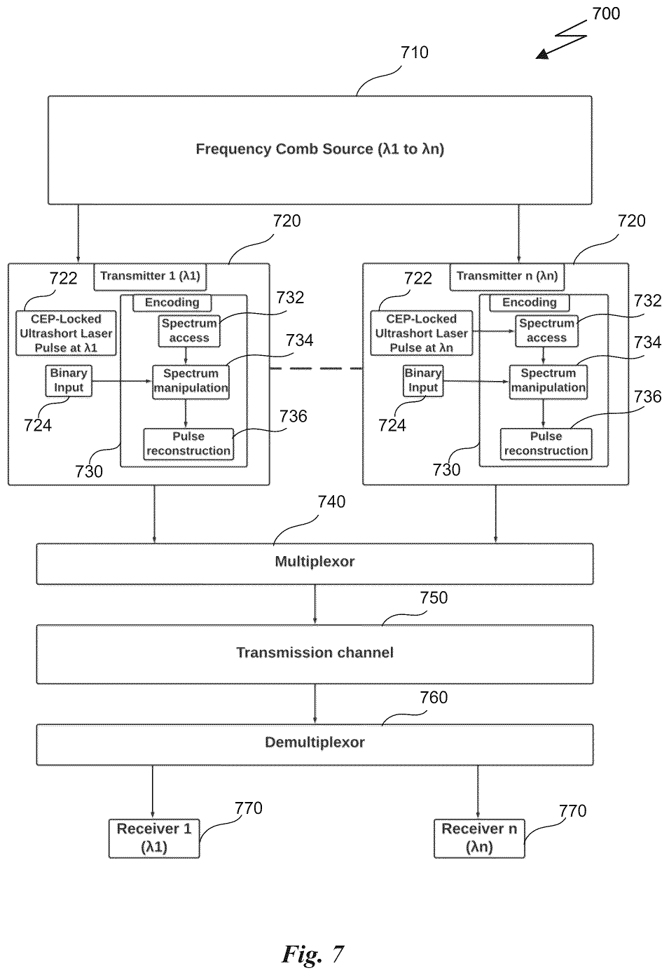

FIG. 7 is a block diagram illustrating an example communication system 700, in accordance with one or more embodiments. Each block of the communication system 700, described herein, may be implemented by any combination of hardware, firmware, and/or software. In at least one embodiment, the communication system 700 may additionally or alternatively be implemented by any one system, or any combination of systems, including, but not limited to, those described herein. Furthermore, persons of ordinary skill in the art will understand that any system configured to perform the functions of the communication system 700 is within the scope and spirit of embodiments of the present disclosure. The communication system 700 may be an embodiment of the communication system 100 in FIG. 1A. Additionally and/or alternatively, various components of communication system 700 may be implemented, in whole or in part, within transmitter 120 and/or receiver 160, as described herein.

At block 710, a frequency comb source is configured to generate ultrashort laser pulses of various wavelengths (λ₁, . . . , λₙ). In at least one embodiment, the ultrashort laser pulses are CEP-locked pulses 722 that are input to the transmitters at blocks 720.

At blocks 720, one or more transmitters are configured to modulate the laser pulses. In at least one embodiment, each transmitter at a block 720 is configured to modulate the CEP-locked laser pulses 722 of a specific wavelength.

In at least one embodiment, each block 720 performs encoding (at block 730) on the respective CEP-locked laser pulses 722 based on a binary input 724. For example, the binary input 724 indicates the data information to be transmitted in a communication network.

In at least one embodiment, at block 730, the encoding includes various processes, such as spectrum access (at block 732), spectrum manipulation (at block 734), and pulse reconstruction (at block 736). In at least one embodiment, at block 732, the spectrum access is facilitated by transforming the temporal pulse signals into the frequency domain. For example, a signal spectrum similar to plot 322 as shown in FIG. 3D may be obtained. At block 734, the spectrum manipulation is implemented by selectively modulating the intensity of frequency components in the signal spectrum. For example, a manipulated signal spectrum similar to plots 334 and 336 as shown in FIG. 3E and FIG. 3F may be obtained. In the illustrated example, the spectrum manipulation is controlled based on the binary input 724. At block 736, the pulse reconstruction is performed by transforming the manipulated signal spectrum back into the time domain. For example, a modified signal in the time domain similar to plots 344 and 346 as shown in FIG. 3E and FIG. 3F may be obtained.

At block 740, a multiplexor is used to perform multiplexing on the modified temporal signals associated with various wavelengths. For example, the multiplexor can combine the temporally modulated optical signals generated by multiple transmitters, each operating at a different wavelength. This process enables wavelength-division multiplexing (WDM), a technique in optical data transmission where multiple data channels—each modulated onto a distinct optical carrier wavelength—are transmitted simultaneously over a single optical medium. While commonly used in fiber optic networks, WDM can also be applied in free-space optical (FSO) communication systems, where the multiplexed optical signals propagate through air or near-vacuum environments instead of through optical fiber. In some implementations, time-division multiplexing (TDM) or hybrid WDM-TDM schemes may also be employed to further increase channel density and spectral efficiency. By multiplexing these wavelength-specific signals, the system can support high-throughput, parallel data transmission while making efficient use of the available optical spectrum, whether in fiber-based or free-space transmission environments.

At block 740, the multiplexed signals are transmitted in one or more transmission channels. In at least one embodiment, the one or more transmission channels serve as the transmission path(s) 140 in FIG. 1A.

In at least one embodiment, the receiving end includes a demultiplexor at block 750 and one or more receivers 760. At block 750, the demultiplexor separates the received signals based on their respective wavelengths. For example, this enables the recovery of individual data channels from the multiplexed transmission. At blocks 760, the receivers recover the data information from the received signals. For example, the receivers reconstruct the binary information corresponding to the respective binary input 724 at the transmitter end. In at least one embodiment, the receivers are configured to detect, based on the CEP of the transmitted signals, at least one intrusion to the data transmission. For example, the receivers may perform method 500 to facilitate detection of intrusion.

In at least one embodiment, in the communication system 700, the frequency comb source at block 710 is a CEP-locked optical frequency comb. Each comb tooth serves as an independent communication channel for ultra-dense wavelength-division multiplexing (UDWDM).

In at least one embodiment, holographic multiplexing is used to increase optical data transfer capacity by enabling the retrieval of multiple independent data streams within a single optical medium. Each data stream corresponds to a distinct hologram, which can be selectively accessed using an interrogating beam with a specific property (e.g., CEP dependence or other distinguishing characteristics). Accordingly, the receiving end, such as at block 760 and/or blocks 770, a respective interrogating beam is used to isolate the corresponding data stream for further process.

All references, including publications, patent applications, and patents, cited herein are hereby incorporated by reference to the same extent as if each reference were individually and specifically indicated to be incorporated by reference and were set forth in its entirety herein.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The T use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A method for data transmission, comprising:
generating a laser pulse in time domain, the laser pulse configured based on a carrier-envelope phase (CEP);
generating, based on the laser pulse, a signal spectrum in frequency domain, the signal spectrum comprising a range of frequencies;
modulating the signal spectrum in the frequency domain by selectively modifying one or more segments of frequencies within the range of frequencies;
generating, based on the modulated signal spectrum in the frequency domain, a modulated laser pulse in the time domain; and
transmitting the modulated laser pulse through a communication network.

2. The method according to claim 1, further comprising:
generating a plurality of laser pulses corresponding to one or more CEPs comprising the CEP;
generating a plurality of modulated laser pulses corresponding to the plurality of laser pulses;
multiplexing the plurality of modulated laser pulses to produce a plurality of multiplexed laser pulses; and
transmitting the plurality of multiplexed laser pulses in the communication network.

3. The method according to claim 2, wherein the plurality of laser pulses are generated by a CEP-locked optical frequency comb, wherein each comb tooth corresponds to an independent communication channel, wherein the plurality of laser pulses correspond to a plurality of independent communication channels, and wherein the communication network comprises a plurality of spectrally discrete communication channels for data transmission.

4. The method according to claim 3, wherein the plurality of laser pulses corresponding to the plurality of independent communication channels are multiplexed based on an ultra-dense wavelength-division multiplexing (UDWDM) scheme and transmitted in the plurality of spectrally discrete communication channels in the communication network.

5. The method according to claim 3, wherein the plurality of modulated laser pulses are multiplexed based on a holographic multiplexing scheme, wherein each modulated laser pulse of the plurality of modulated laser pulses is associated with an interrogating beam, and wherein the interrogating beam is used to isolate the respective modulated laser pulse from the plurality of multiplexed laser pulses at a receiving end.

6. The method according to claim 1, wherein in the frequency domain, the signal spectrum is associated with light spatially distributed across an optical plane, with the spatial distribution corresponding to the frequencies within the frequency range.

7. The method according to claim 6, wherein modulating the signal spectrum in the frequency domain comprises at least one of:
modulating, on the optical plane and using a spatial light modulator (SLM), an amplitude of the one or more segments of frequency within the range of frequencies; or
blocking one or more segments of frequency within the range of frequencies.

8. The method according to claim 1, wherein modulating the signal spectrum in the frequency domain encodes the laser pulse to carry multi-bit information.

9. The method according to claim 1, wherein the communication network comprises at least one of:
fiber optics;
atmospheric channels; and
vacuum or near-vacuum communication paths.

10. The method according to claim 1, wherein the laser pulse is a CEP-locked ultrashort pulse, wherein a duration of the CEP-locked ultrashort pulse ranges between 1 femtoseconds and 100 femtoseconds.

11. The method according to claim 1, further comprising:
receiving the modulated laser pulse from the communication network;
determining a second CEP for the received modulated laser pulse based on propagation of the modulated laser pulse through the communication network;
detecting at least one intrusion attack based on the first CEP and the second CEP; and
triggering an alarm based on detecting the at least one intrusion attack.

12. The method according to claim 11, wherein detecting the at least one intrusion attack comprises:
determining a phase shift in CEP based on the first CEP and the second CEP; and
determining that the phase shift satisfies a condition corresponding to a reference phase shift.

13. A device for data transmission, comprising:
a light source configured to obtain a laser pulse in time domain, the laser pulse configured based on a first carrier-envelope phase (CEP);
an optical system comprising one or more optical components, the optical system configured to obtain, based on the laser pulse, a signal spectrum in frequency domain, the signal spectrum comprising a range of frequencies; and
a modulator configured to modulate the signal spectra in the frequency domain by selectively modifying one or more segments of frequencies within the range of frequencies,
wherein the optical system is further configured to:
obtain, based on the modulated signal spectrum in the frequency domain, a modulated laser pulse in the time domain; and
transmit the modulated light signal through a communication network.

14. The device according to claim 13,
wherein the light source is further configured to generate a plurality of laser pulses corresponding to one or more CEPs comprising the CEP,
wherein the optical system is further configured to obtain, based on the plurality of laser pulses, a plurality of signal spectra in frequency domain,
wherein the modulator is further configured to modulate the plurality of signal spectra, and
wherein the optical system is further configured to:
obtain, based on the plurality of modulated signal spectra, a plurality of modulated laser pulses in the time domain;
multiplex the plurality of modulated laser pulses to produce a plurality of multiplexed laser pulses; and
transmit the plurality of multiplexed laser pulses in the communication network.

15. The device according to claim 14, wherein the light source is a CEP-locked optical frequency comb, wherein each comb tooth corresponds to an independent communication channel, wherein the plurality of laser pulses correspond to a plurality of independent communication channels, and wherein the communication network comprises a plurality of spectrally discrete communication channels for data transmission.

16. The device according to claim 14, wherein the plurality of laser pulses corresponding to the plurality of independent communication channels are multiplexed based on an ultra-dense wavelength-division multiplexing (UDWDM) scheme and transmitted in the plurality of spectrally discrete communication channels in the communication network.

17. The device according to claim 14, wherein the plurality of modulated laser pulses are multiplexed based on a holographic multiplexing scheme, wherein each modulated laser pulse of the plurality of modulated laser pulses is associated with an interrogating beam, and wherein the interrogating beam is used to isolate the respective modulated laser pulse from the plurality of multiplexed laser pulses at a receiving end.

18. The device according to claim 13, wherein modulating the signal spectrum in the frequency domain encodes the laser pulse to carry multi-bit information.

19. A device for data transmission, comprising:
one or more processors configured to:
determine, for a laser pulse received from a communication network, a carrier-envelope phase (CEP) of the laser pulse;
determine a difference between the CEP of the laser pulse and a reference CEP corresponding to the data transmission using the laser pulse; and
detect, based on the difference between the CEP and the reference CEP, existence of at least one intrusion during the data transmission.

20. The device according to claim 19, wherein the laser pulse received from the communication network is isolated from a plurality of multiplexed laser pulses by a demultiplexer.
